(19) United States
(12) Patent Application Publication
(10) Pub. No.: US 2026/0301639 A1
(43) Pub. Date: Oct. 1, 2026

(54) TILED DISPLAY DEVICE AND DRIVING METHOD THEREOF

(71) Applicant: AUO Corporation, Hsinchu city (TW)

(72) Inventors: Hong-Sian CHI, Hsinchu city (TW); Yi-Fu OU, Hsinchu city (TW); Yung-Chih CHEN, Hsinchu city (TW); Ssu-Hsien CHIH, Hsinchu city (TW); Shin-Ru LIN, Hsinchu city (TW); Yu-Chieh LIN, Hsinchu city (TW)

(21) Appl. No.: 19/341,140

(22) Filed: Sep. 26, 2025

(30) Foreign Application Priority Data
Mar. 28, 2025 (TW) 114112197

(51) Int. Cl. G09G 3/20

(52) U.S. Cl. CPC G09G 3/2092; G09G 2300/026; G09G 2310/08; G09G 2320/0233

(57) ABSTRACT

A tiled display device includes a signal source, a processor and a plurality of displays. The signal source provides a display signal. The processor receives the display signal. The processor includes a detecting element. The displays display a screen according to the display signal. Adjacent two of the displays are arranged in tiled. Each of the displays has a display region and a boundary region, and includes a driving circuit, a plurality of pixel units and a plurality of boundary pixel units. The pixel units are located at the display region. The boundary pixel units are located at the boundary region. The detecting element generates a detecting signal according to a displaying status of the displays. The processor determines whether to output a compensating controlling signal according to the detecting signal. The driving circuit adjusts a brightness of the boundary pixel units according to the compensating controlling signal.

### RELATED APPLICATIONS

This application claims priority to Taiwan Application Serial Number 114112197, filed Mar. 28, 2025, which is herein incorporated by reference.

### BACKGROUND

### Technical Field

The present disclosure relates to a display device and a driving method thereof. More particularly, the present disclosure relates to a tiled display device and a driving method thereof.

### Description of Related Art

Due to the development and popularization of the manufacturing technique of the display device, the applied field of display device can be expanded by tiling multiple display devices. For example, large display device can be applied to advertising board, or the display devices can be electrically connected by flexible printed circuit, so that the display can be folded, and the portability can be increased. However, either large size display or small size display, even if the boundary width is thinner, a tiled gap is still exists between the adjacent two display devices. The tiled gap forms a dark area, and the display screen will be discontinuous. In order to improve the display effect, an optical compensation method is provided to adjust and modify the display.

### SUMMARY

According to one aspect of the present disclosure, a tiled display device includes a signal source, a processor and a plurality of displays. The signal source provides a display signal. The processor is signally connected to the signal source, and receives the display signal. The processor includes a detecting element. The displays are signally connected to the processor, and display a screen according to the display signal. Adjacent two of the displays are arranged in tiled. Each of the displays has a display region and a boundary region, and includes a driving circuit, a plurality of pixel units and a plurality of boundary pixel units. The pixel units are signally connected to the driving circuit, and located at the display region. The boundary region of one of the displays is closer to another one of the displays, which is adjacent to the one of the displays, than the display region of the one of the displays to another one of the displays. The boundary pixel units are signally connected to the driving circuit, and located at the boundary region. The detecting element generates a detecting signal according to a displaying status of the displays. The processor determines whether to output a compensating controlling signal according to the detecting signal. The driving circuit adjusts a brightness of the boundary pixel units according to the compensating controlling signal.

According to another aspect of the present disclosure, a driving method of a tiled display device includes driving a signal source to output a display signal to a processor; driving a detecting element of the processor to detect a displaying status of a plurality of displays of the tiled display device to generate a detecting signal; driving the processor to determine whether to output a compensating controlling signal according to the detecting signal; driving a plurality of driving circuits of the displays to adjust a brightness of a plurality of boundary pixel units, which are located at a boundary region of each of the displays, according to the compensating controlling signal; and driving the boundary pixel units of the displays and a plurality of pixel units, which are located at a display region of each of the displays, to display a screen.

### BRIEF DESCRIPTION OF THE DRAWINGS

The present disclosure can be more fully understood by reading the following detailed description of the embodiment, with reference made to the accompanying drawings as follows:

FIG. 1 shows a schematic view of a tiled display device according to embodiments of the present disclosure.

FIG. 2 shows a block diagram of a driving method of a tiled display device according to embodiments of the present disclosure.

FIG. 3A shows a partial schematic view of displays of a tiled display device according to embodiments of the present disclosure.

FIG. 3B shows a sequence diagram for driving displays of the tiled display device in FIG. 3A.

FIG. 4A shows a partial schematic view of displays of the tiled display device according to embodiments of the present disclosure.

FIG. 4B shows a sequence diagram for driving displays of the tiled display device in FIG. 4A.

FIG. 5A shows a partial schematic view of displays of the tiled display device according to embodiments of the present disclosure.

FIG. 5B shows a sequence diagram for driving displays of the tiled display device in FIG. 5A.

FIG. 6A shows a partial schematic view of displays of the tiled display device according to embodiments of the present disclosure.

FIG. 6B shows a sequence diagram for driving displays of the tiled display device in FIG. 6A.

FIG. 7 shows a schematic view of a display screen displayed by a tiled display device according to embodiments of the present disclosure.

### DETAILED DESCRIPTION

The components and the configurations in the following description are only for illustration, and the present disclosure is not limited thereto. In order to clearly present the technical features of the present disclosure, the dimensions (such as length, width, thickness, and depth) of elements (such as layers, films, substrates, and areas) in the drawings will be enlarged in unusual proportions. Accordingly, the description and explanation of the following embodiments are not limited to the quantities, sizes and shapes of the elements presented in the drawings, but should cover the sizes, shapes, and deviations of the two due to actual manufacturing processes and/or tolerances. For example, the flat surface shown in the drawings may have rough and/or non-linear characteristics, and the acute angle shown in the drawings may be round. Therefore, the elements presented in the drawings in this case which are mainly for illustration are intended neither to accurately depict the actual shape and quantity of the elements nor to limit the scope of patent applications in this case. Moreover, the repeated reference symbols and/or labels in each of the embodiments of the present disclosure are not limited in the discussed embodiments and/or the relationships between the components.

It will be understood that when an element (or device) is referred to as be “connected to” another element, it can be directly connected to other element, or it can be indirectly connected to the other element, that is, intervening elements may be present. In contrast, when an element is referred to as be “directly connected to” another element, there are no intervening elements present. In addition, the terms first, second, third, etc. are used herein to describe various elements or components, these elements or components should not be limited by these terms. Consequently, a first element or component discussed below could be termed a second element or component.

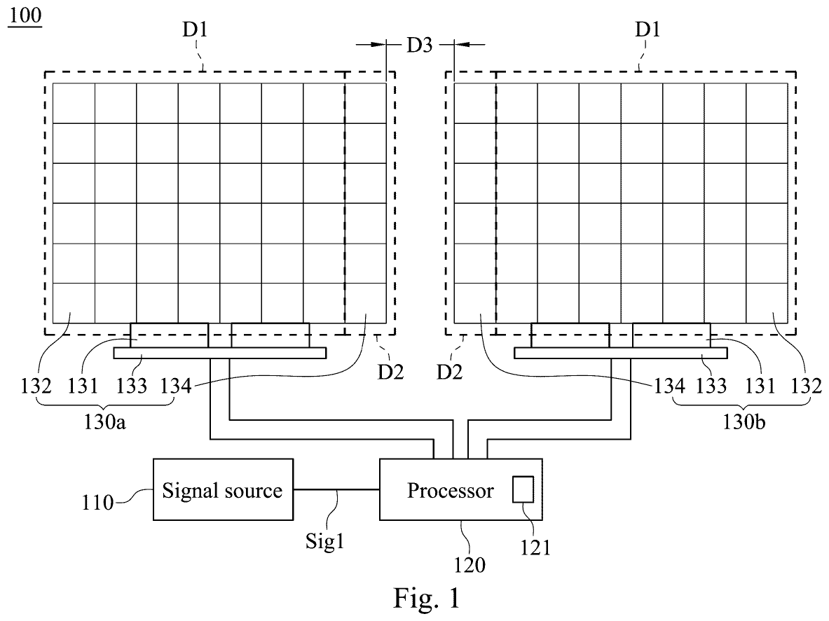

Please refer to FIG. 1. FIG. 1 shows a schematic view of a tiled display device 100 according to embodiments of the present disclosure. The tiled display device 100 includes a signal source 110, a processor 120 and a plurality of displays 130a, 130b. The signal source 110 provides a display signal Sig1. The processor 120 is signally connected to the signal source 110, and receives the display signal Sig1. The processor 120 includes a detecting element 121. The displays 130a, 130b are signally connected to the processor 120, and display a screen according to the display signal Sig1. Adjacent two of the displays 130a, 130b are arranged in tiled. Each of the displays 130a, 130b has a display region D1 and a boundary region D2, and includes a driving circuit 131, a plurality of pixel units 132, a flexible printed circuit board 133 and a plurality of boundary pixel units 134. The pixel units 132 are signally connected to the driving circuit 131, and located at the display region D1. The boundary region D2 of the display 130a is closer to the display 130b, which is adjacent to the display 130a, than the display region D1 of the display 130a to the display 130b. The boundary pixel units 134 are signally connected to the driving circuit 131, and located at the boundary region D2.

In detail, the processor can be a computing device with image processing function, such as a Central Processing Unit (CPU), a Graphics Processing unit (GPU) or an Image Signal Processor (ISP), but the present disclosure is not limited thereto. The detecting element 121 can be an external sensor, or disposed in the displays 130a, 130b, and the detecting element 121 is configured to detect a displaying status of the displays 130a, 130b is individual displaying status or tiled displaying status. A number of the displays 130a, 130b is at least two, and the displays 130a, 130b can be tiled along arbitrary directions. The boundary region D2 of the display 130a can be located at a side of the display 130a, which is connected to the adjacent display 130b. The driving circuit 131 is configured to drive the pixel units 132 and the boundary pixel units 134 to emit a light. In the embodiments of the present disclosure, each of the pixel units 132 and each of the boundary pixel units 134 can be one light emitting element or multiple light emitting elements, but the present disclosure is not limited thereto.

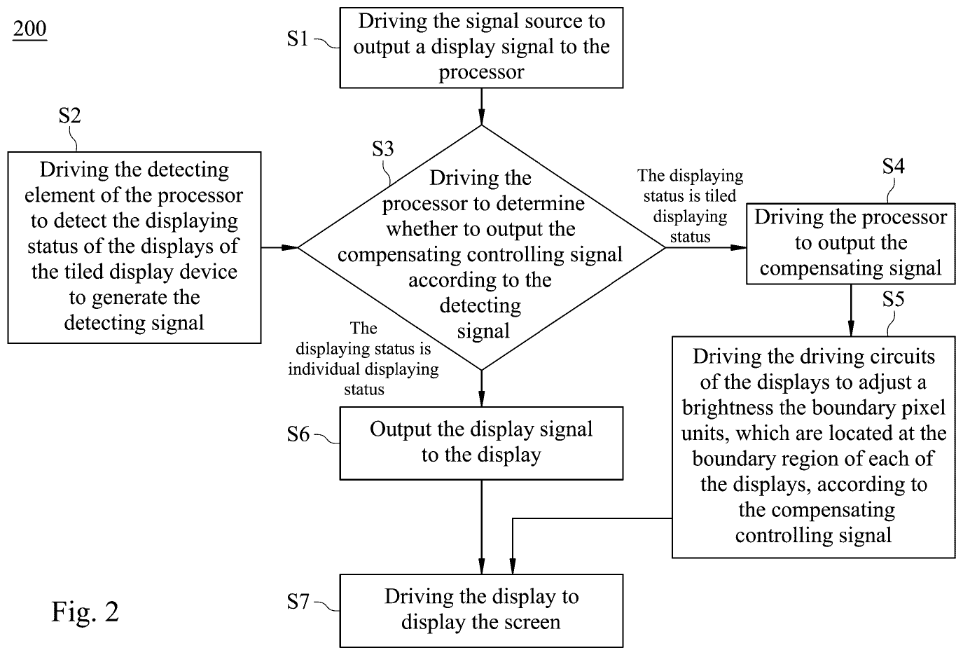

Please refer to FIG. 1 and FIG. 2. FIG. 2 shows a block diagram of a driving method 200 of the tiled display device 100 according to embodiments of the present disclosure. The driving method 200 of the tiled display device 100 includes steps S1, S2, S3, S4, S5, S6, S7. The step S1 includes driving the signal source 110 to output a display signal Sig1 to the processor 120. The step S2 includes driving a detecting element 121 of the processor 120 to detect the displaying status of the displays 130a, 130b of the tiled display device 100 to generate a detecting signal. The step S3 includes driving the processor 120 to determine whether to output the compensating controlling signal according to the detecting signal. The step S4 includes driving the processor 120 to output the compensating controlling signal. The step S5 includes driving a plurality of driving circuits 131 of the displays 130a, 130b to adjust a brightness of the boundary pixel units 134, which are located at the boundary region D2 of each of the displays 130a, 130b, according to the compensating controlling signal. The step S6 includes outputting the display signal Sig1 to the displays 130a, 130b. The step S7 includes driving the boundary pixel units 134 of the displays 130a, 130b and the pixel units 132, which are located at the display region D1 of each of the displays 130a, 130b, to display a screen.

In detail, the step S1 is configured to transmit the display signal Sig1 to the processor 120. In the step S2, the detecting element 121 detects the displaying status of the displays 130a, 130b is individual displaying status or tiled displaying status. The individual displaying status representing the display 130a and the display 130b are not tiled, the display screen displayed on the display 130a and the display screen displayed on the display screen are not relevant. The tiled displaying status represents the displays 130a, 130b display a part and another part of a display screen, respectively. In the step S3, the processor 120 determines the displaying status, when the displaying status is individual displaying status, the boundary region D2 of the displays 130a, 130b don't need to be compensated, and the step S6 is performed. When displaying status is tiled displaying status, the step S4 is performed. In the step S4, the compensating controlling signal is transmitted from the processor 120 to the driving circuits 131 of the displays 130a, 130b via the flexible printed circuit board 133. In the step S5, the brightness of the boundary pixel units 134 of the displays 130a, 130b are compensated according to the compensating controlling signal. In the step S6, the display signal Sig1 is outputted to the displays 130a, 130b, which are not tiled. In the step S7, the displays 130a, 130b display the display screen according to the display signal Sig1 and the compensating controlling signal.

Generally, each of the displays 130a, 130b of the tiled display device 100 usually has a bezel, hence, there is a tiled gap between two tiled displays 130a, 130b. The tiled display device 100 of the present disclosure can compensate the brightness of the boundary pixel units 134 located at the boundary region D2, so as to reduce the discontinuous visual effect caused by the tiled gap. By changing the brightness of the boundary region D2, the discontinuous visual effect can be blurred and weaken. The details of compensating the brightness of the boundary pixel units 134 of the driving method 200 of the tiled display device 100 will be described in detail as below.

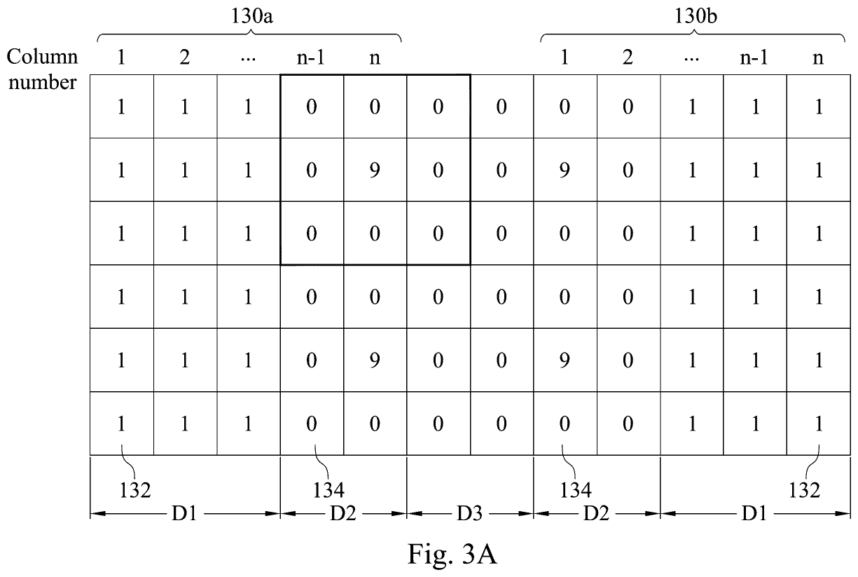

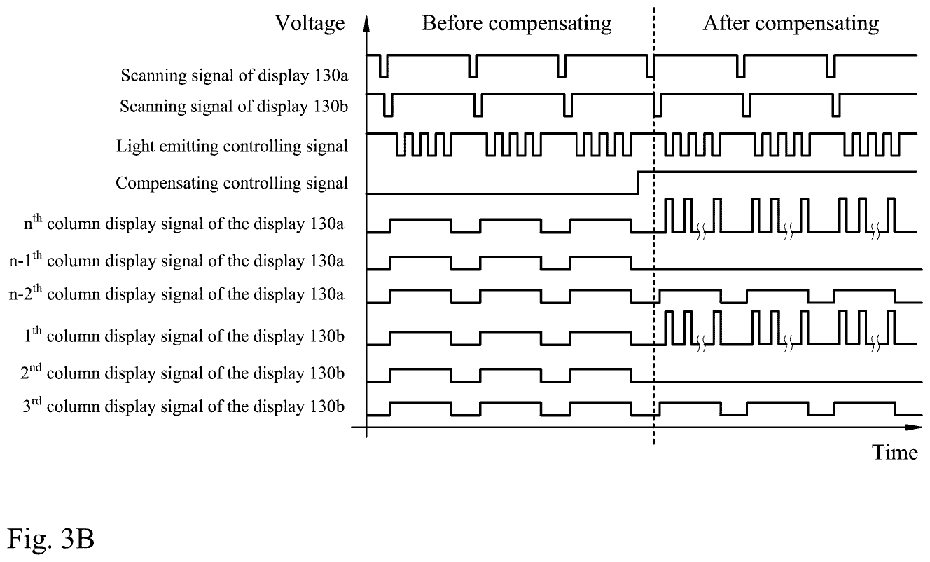

Please refer to FIG. 3A and FIG. 3B. FIG. 3A shows a partial schematic view of displays 130a, 130b of a tiled display device 100 according to embodiments of the present disclosure. FIG. 3B shows a sequence diagram for driving displays 130a, 130b of the tiled display device 100 in FIG. 3A. In FIG. 3A, the brightness corresponding to a part of the pixel units 132 of the display region D1 of the display 130a, the boundary pixel units 134 of the boundary region D2 of the display 130a, a gap region D3 between the displays 130a, 130b, the boundary pixel units 134 of the boundary region D2 of the display 130b and a part of the pixel units 132 of the display region D1 of the display 130b are shown from the left to the right in sequence. In FIG. 3A, the number ‘1’, ‘0’, ‘9’ in the pixel units 132 and the boundary pixel units 134 only represent a ratio of the brightness between the adjacent pixel units (i.e., the pixel units 132 and the boundary pixel units 134), the number 1′, ‘0’, ‘9’ do not represent the actual brightness value of the aforementioned pixel units. A distance (i.e., the gap region D3) of adjacent two of the displays 130a, 130b is the same as a width of a portion of the boundary pixel units 134, a number of the portion of the boundary pixel units 134 is 2 A. The boundary pixel units 134 are divided into a plurality of areas, each of the areas includes B boundary pixel units 134, and is satisfied by the following conditions (1) and (2):

$$B = C \times D ; and \qquad ( 1 )$$

$$C \geq 2 , and D \geq 1. \qquad ( 2 )$$

C and D represent a number of the rows and a number of the columns of each of the areas, respectively. The n−1^{th} column and the n^{th} column boundary pixel units 134 of the display 130a are located at the boundary region D2. The 1st, 2nd columns boundary pixel units of the display 130b are located at the boundary region. The driving circuit 131 adjusts the brightness of the B boundary pixel units 134 located at the boundary region D2 according to the compensating controlling signal.

Take FIG. 3A as an example, a distance between the displays 130a, 130b is equal to a width of 2 boundary pixel units 134, that is, A is equal to 1. Every areas includes 6 boundary pixel units 134, and are consists of 3 rows and 2 columns of boundary pixel units 134, that is, B is equal to 6, C is equal to 3, and D is equal to 2. In other embodiments of the present disclosure, A can be non-integer, the row number, the column number and the number of the boundary pixel units 134 of each areas can be adjusted under the conditions (1) and (2), but the present disclosure is not limited thereto. Thus, the boundary region D2 are divided into multiple areas, the brightness of the boundary pixel units 134 near to the gap region D3 between adjacent two displays 130a, 130b are compensated, so that every areas can remain same average brightness, the visual brightness of the boundary region D2 can be weakened, and the gap between the displays 130a, 130b can be soften.

Moreover, the brightness of the one of B boundary pixel units 134 of each of the areas is C×(D+A) times of a brightness of the pixel units 132, and a brightness of the other of the boundary pixel units 134 in each of the areas is zero. In FIG. 3A, the driving circuit 131 is configured to adjust the brightness of the 2^{nd}, 5^{th} boundary pixel units 134 of the n^{th} column of the display 130a, and the 2^{nd}, 5^{th} boundary pixel units 134 of the 1^{st} column of the display 130b. In other embodiments of the present disclosure, the driving circuit can adjust the brightness of one of the other boundary pixel units 134 in each areas, but the present disclosure is not limited thereto.

FIG. 3B shows the sequence diagram of the scanning signal outputted from the driving circuit 131 of the displays 130a, 130b, the light emitting controlling signal, the compensating controlling signal and the display signal of the boundary pixel units 134 of each of the columns before/after compensating while the compensating controlling signals are transmitted to the driving circuit 131.

In the driving method 200 of the tiled display device 100 of the present disclosure, after the boundary pixel units 134 of the displays 130a, 130b of the tiled display device 100 are determined to compensate by the manner in FIG. 3A, the ratio between the compensating brightness of each of the boundary pixel units 134 and the pixel units 132 can be checked up from a table to transform into the gray scale value, and calculates the brightness compensation ratio from the gray scale value.

Take FIG. 3A as an example, a brightness ratio between the pixel unit 132 and the boundary pixel unit 134 is 1:9, a maximum brightness of the boundary pixel units 134 is predetermined to be the brightest (100%), and the brightness of the pixel units 132 is calculated to be 11.11%. According to check up a table between the gray scale and the brightness percentage of the displays 130a, 130b, the brightness 11.11% is corresponding to 94 gray scale, and a ratio between the 94 gray scale and the maximum gray scale (255 gray scale) is 36.8%, that is, the brightness compensating ratio of FIG. 3A is 36.8%. In other embodiments of the present disclosure, the gray scale value corresponding to the brightness of the pixel units can be adjusted according to the actual specification of the display, but the present disclosure is not limited thereto.

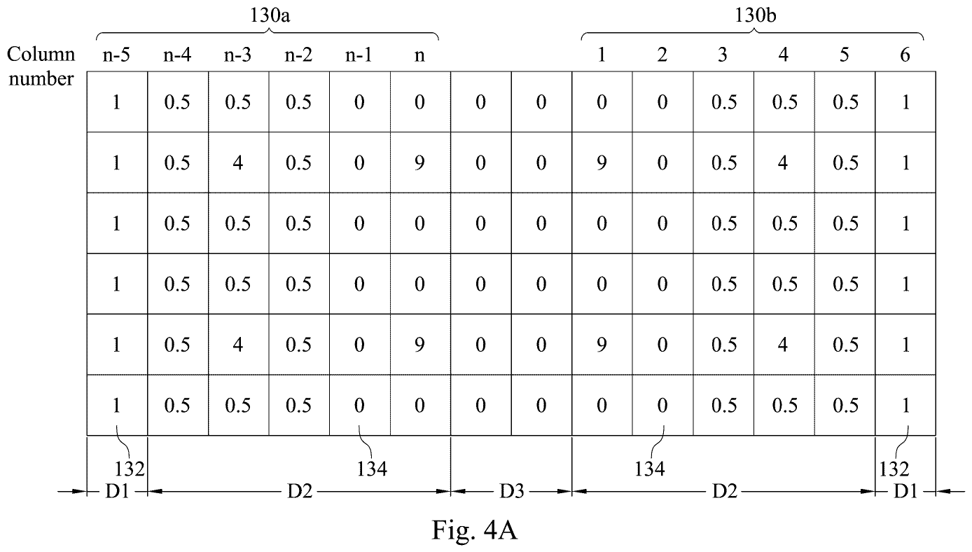

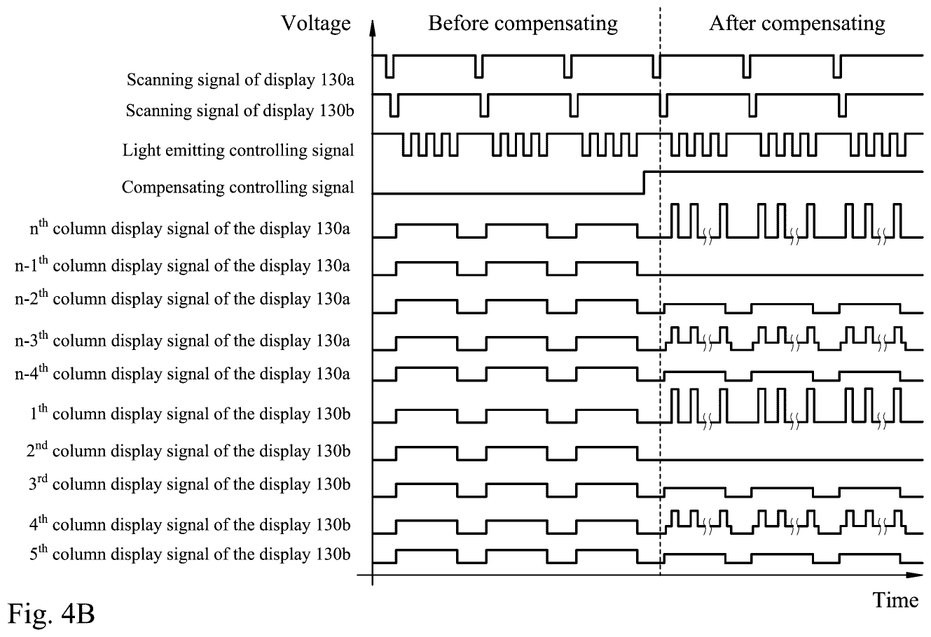

Please refer to FIG. 4A and FIG. 4B. FIG. 4A shows a partial schematic view of displays 130a, 130b of the tiled display device 100 according to embodiments of the present disclosure. FIG. 4B shows a sequence diagram for driving displays 130a, 130b of the tiled display device 100 in FIG. 4A. FIG. 4A shows another compensating manner for the tiled display device 100. In FIG. 4A, the brightness corresponding to a part of the pixel units 132 of the display region D1 of the display 130a, the boundary pixel units 134 of the boundary region D2 of the display 130a, a gap region D3 between the displays 130a, 130b, the boundary pixel units 134 of the boundary region D2 of the display 130b and a part of the pixel units 132 of the display region D1 of the display 130b are shown from the left to the right in sequence. In FIG. 4A, the number ‘1’, ‘0’, ‘0.5’, ‘4’, ‘9’ in the pixel units 132 and the boundary pixel units 134 only represent a ratio relationship of the brightness between the adjacent pixel units (i.e., the pixel units 132 and the boundary pixel units 134), the number 1′, ‘0’, ‘0.5’, ‘4’, ‘9’ do not represent the actual brightness value of the aforementioned pixel units.

In FIG. 4A, the n−4^{th}, n−3^{th}, n−2^{th}, n−1^{th}, n^{th} columns boundary pixel units 134 of the display 130a are located at the boundary region D2, the 1^{st}-5^{th} columns boundary pixel units 134 of the display 130b are located at the boundary region D2. The brightness compensating manner of the n−1^{th}, n^{th} columns of the display 130a and the 1^{st}-2^{nd} columns of the display 130b are the same as FIG. 3A, and will not be described again. In the n−4^{th}, n−3^{th}, n−2^{th} columns boundary pixel units 134 in the display 130a, the 3^{rd}-5^{th} columns boundary pixel units 134 in the display 130b, the brightness of the 2^{nd} and the 5^{th} boundary pixel units 134 in the n−3^{th} column of the display 130a and the 4^{th} column of the display 130b are 4 times of the brightness of the pixel units 132, and the brightness of other boundary pixel units 134 are 0.5 times of the pixel units 132.

FIG. 4B shows the sequence diagram of the scanning signal outputted from the driving circuit 131 of the displays 130a, 130b, the light emitting controlling signal, the compensating controlling signal and the display signal of the boundary pixel units 134 of each of the columns before/after compensating while the compensating controlling signals are transmitted to the driving circuit 131.

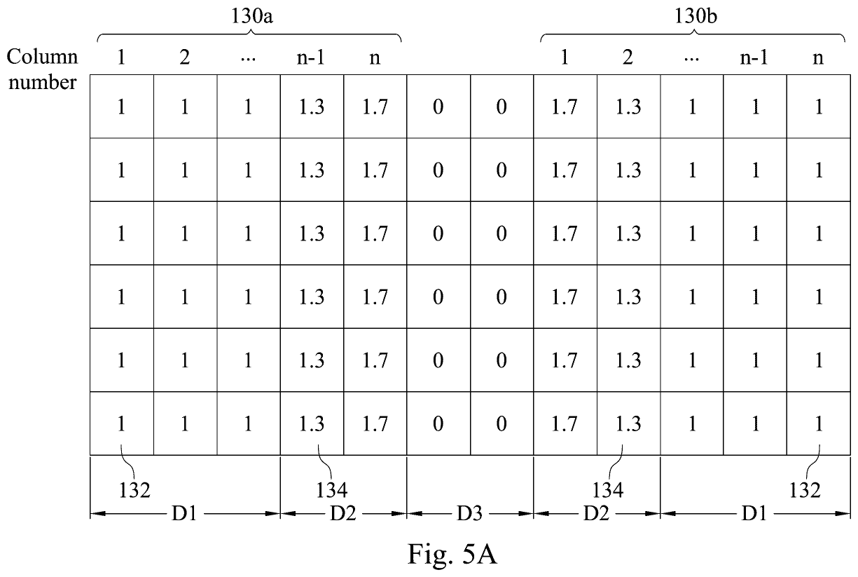

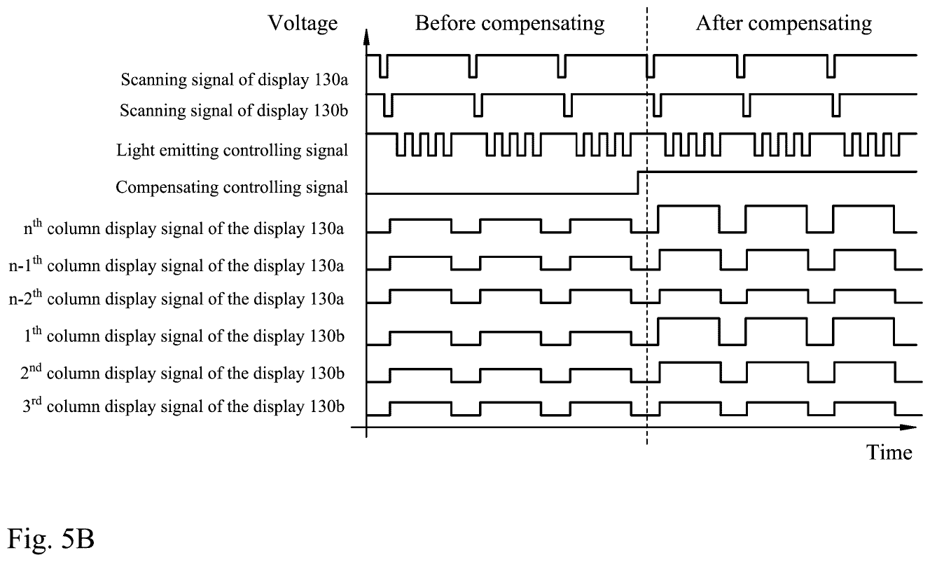

Please refer to FIG. 5A and FIG. 5B. FIG. 5A shows a partial schematic view of displays 130a, 130b of the tiled display device 100 according to embodiments of the present disclosure. FIG. 5B shows a sequence diagram for driving displays 130a, 130b of the tiled display device 100 in FIG. 5A. FIG. 5A shows further another compensating manner for the tiled display device 100. In FIG. 5A, the brightness corresponding to a part of the pixel units 132 of the display region D1 of the display 130a, the boundary pixel units 134 of the boundary region D2 of the display 130a, a gap region D3 between the displays 130a, 130b, the boundary pixel units 134 of the boundary region D2 of the display 130b and a part of the pixel units 132 of the display region D1 of the display 130b are shown from the left to the right in sequence. In FIG. 5A, the number ‘1’, ‘0’, ‘1.3’, ‘1.7’ in the pixel units 132 and the boundary pixel units 134 only represent a ratio relationship of the brightness between the adjacent pixel units (i.e., the pixel units 132 and the boundary pixel units 134), the number 1′, ‘0’, ‘1.3’, ‘1.7’ do not represent the actual brightness value of the aforementioned pixel units.

The boundary pixel unit 134 includes a first column pixel unit and a second column pixel unit, the first column pixel unit has a first brightness, the second column pixel unit has a second brightness, the pixel units 132 have a third brightness, and both of the first brightness and the second brightness are greater than the third brightness.

In FIG. 5A, the first column pixel unit can be the n−1^{th} column pixel unit in the display 130a and the 2^{nd} column pixel unit in the display 130b. The second column pixel unit can be the n^{th} column pixel unit in the display 130a and the 1^{st} column pixel unit in the display 130b. The first brightness is 1.3 times of the third brightness, the second brightness is the 1.7 times of the third brightness. The two first column pixel units and two second column pixel units of the displays 130a, 130b are disposed symmetrically, but the present disclosure is not limited thereto. Therefore, the brightness of boundary pixel units 134 located at the boundary region D2 are compensated, and presents a gradient visual effect to weaken the discontinuous visual effect of the gap between the displays 130a, 130b. In other embodiments of the present disclosure, the first brightness can be the same as the second brightness, but the present disclosure is not limited thereto.

FIG. 5B shows the sequence diagram of the scanning signal outputted from the driving circuit 131 of the displays 130a, 130b, the light emitting controlling signal, the compensating controlling signal and the display signal of the boundary pixel units 134 of each of the columns before/after compensating while the compensating controlling signals are transmitted to the driving circuit 131.

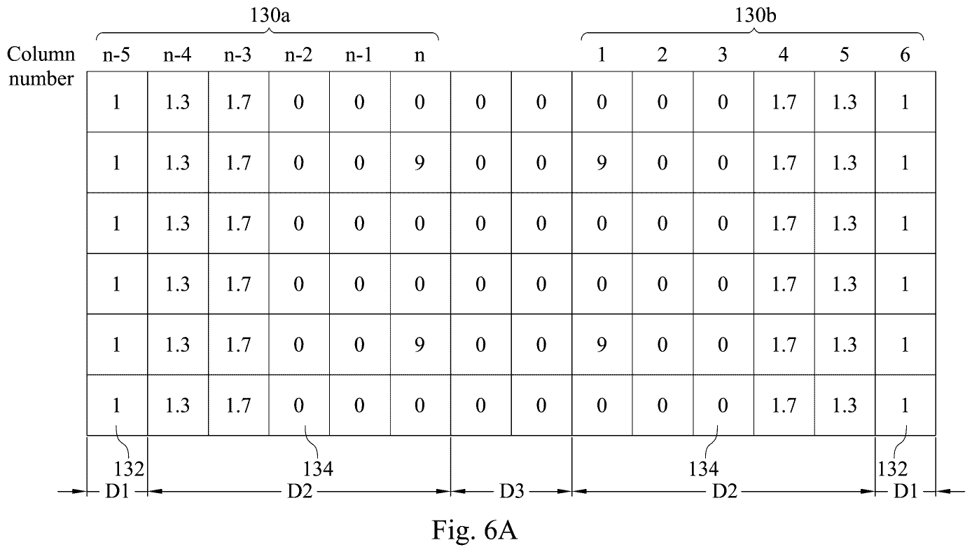

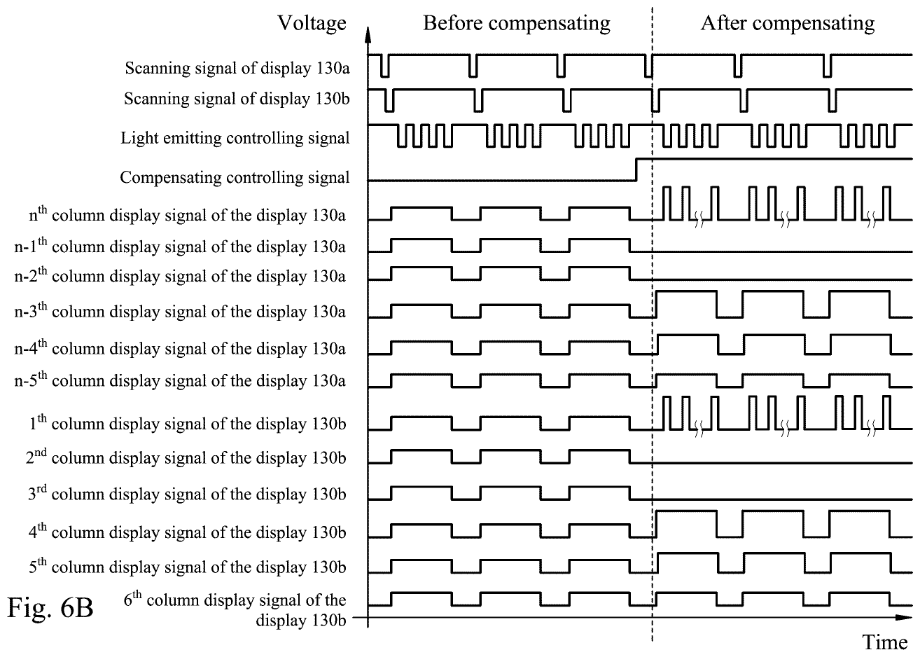

Please refer to FIG. 6A and FIG. 6B. FIG. 6A shows a partial schematic view of displays 130a, 130b of the tiled display device 100 according to embodiments of the present disclosure. FIG. 6B shows a sequence diagram for driving displays 130a, 130b of the tiled display device 100 in FIG. 6A. FIG. 6A shows yet another compensating manner for the tiled display device 100. In FIG. 6A, the brightness corresponding to a part of the pixel units 132 of the display region D1 of the display 130a, the boundary pixel units 134 of the boundary region D2 of the display 130a, a gap region D3 between the displays 130a, 130b, the boundary pixel units 134 of the boundary region D2 of the display 130b and a part of the pixel units 132 of the display region D1 of the display 130b are shown from the left to the right in sequence. In FIG. 6A, the number ‘1’, ‘1.3’, ‘1.7’, ‘0’, ‘9’ in the pixel units 132 and the boundary pixel units 134 only represent a ratio relationship of the brightness between the adjacent pixel units (i.e., the pixel units 132 and the boundary pixel units 134), the number 1′, ‘1.3’, ‘1.7’. ‘0’. ‘9’ do not represent the actual brightness value of the aforementioned pixel units.

In FIG. 6A, the n−4^{th}, n−3^{th}, n−2^{th}, n−1^{th}, n^{th} columns boundary pixel units 134 of the display 130a are located at the boundary region D2, the 1^{st}-5^{th} columns boundary pixel units 134 of the display 130b are located at the boundary region D2. The compensating manner of FIG. 6A combines the compensating manner in FIG. 3A and FIG. 5A, and will not be described again.

FIG. 6B shows the sequence diagram of the scanning signal outputted from the driving circuit 131 of the displays 130a, 130b, the light emitting controlling signal, the compensating controlling signal and the display signal of the boundary pixel units 134 of each of the columns before/after compensating while the compensating controlling signals are transmitted to the driving circuit 131.

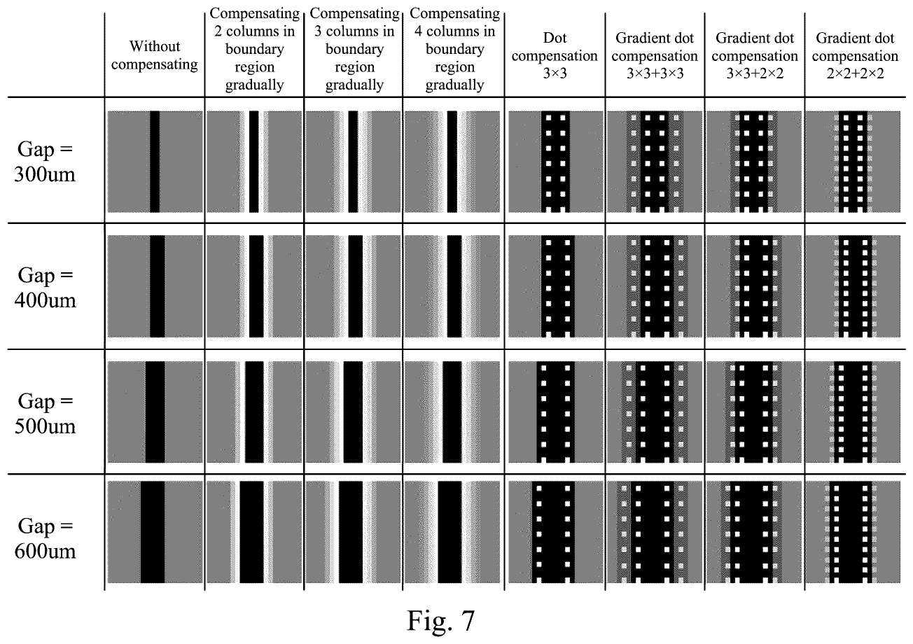

Please refer to FIG. 1 to FIG. 7, FIG. 7 shows a schematic view of a display screen displayed by a tiled display device 100 according to embodiments of the present disclosure. FIG. 7 shows the image of the displays 130a, 130b with the tiled gap between 300 μm to 600 μm while using different brightness compensating manner. FIG. 7 includes boundary pixel units without compensating, compensating 2 columns in boundary region gradually, compensating 3 columns in boundary region gradually, compensating 4 columns in boundary region gradually, dot compensation 3×3, gradient dot compensation 3×3+3×3, gradient dot compensation 3×3+2×2 and gradient dot compensation 2×2+2×2. Compensating 2 columns in boundary region gradually is corresponding to the compensating manner in FIG. 5A. Dot compensation 3×3 is corresponding to the compensating manner in FIG. 3A. Gradient dot compensation 3×3+3×3, gradient dot compensation 3×3+2×2 and gradient dot compensation 2×2+2×2 are corresponding to the compensating manner in FIG. 4A, and adjusts the column number and the row number of each areas.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

1. A tiled display device, comprising:
a signal source providing a display signal;
a processor signally connected to the signal source, receiving the display signal, and comprising:
a detecting element; and
a plurality of displays signally connected to the processor, displaying a screen according to the display signal, wherein adjacent two of the displays are arranged in tiled, each of the displays has a display region and a boundary region, and comprises:
a driving circuit;
a plurality of pixel units signally connected to the driving circuit, and located at the display region, wherein the boundary region of one of the displays is closer to another one of the displays, which is adjacent to the one of the displays, than the display region of the one of the displays to the another one of the displays; and
a plurality of boundary pixel units signally connected to the driving circuit, and located at the boundary region;
wherein the detecting element generates a detecting signal according to a displaying status of the displays, the processor determines whether to output a compensating controlling signal according to the detecting signal, and the driving circuit adjusts a brightness of the boundary pixel units according to the compensating controlling signal;
wherein when the displaying status is an individual displaying status, the boundary region of each of the displays is not compensated.

2. The tiled display device of claim 1, wherein the boundary pixel units are divided into a plurality of areas, each of the areas comprises a portion of the boundary pixel units, each of the areas comprises B boundary pixel units, and is satisfied by the following condition:
$$B = C \times D ; and$$
$$C \geq 2 , and D \geq 1 ;$$
wherein C and D represent a number of a plurality of rows and a number of a plurality of columns of each of the areas, respectively, and the driving circuit adjusts the brightness of one of B boundary pixel units of each of the areas according to the compensating controlling signal.

3. The tiled display device of claim 2, wherein a distance of adjacent two of the displays is the same as a width of another portion of the boundary pixel units, a number of the another portion of the boundary pixel units is 2 A, the brightness of the one of B boundary pixel units of each of the areas is C×(D+A) times of a brightness of the pixel units, and a brightness of the other of the boundary pixel units in each of the areas is zero.

4. The tiled display device of claim 1, wherein the boundary pixel units comprises a first column pixel unit and a second column pixel unit, the first column pixel unit has a first brightness, the second column pixel unit has a second brightness, the pixel units have a third brightness, and both of the first brightness and the second brightness are greater than the third brightness.

5. The tiled display device of claim 4, wherein two first column pixel units and two second column pixel units of the adjacent two of the displays are disposed symmetrically.

6. The tiled display device of claim 1, wherein the processor is one of a Central Processing Unit (CPU), a Graphics Processing Unit (GPU) or an Image Signal Processor (ISP).

7. The tiled display device of claim 1, wherein a number of the displays is at least two.

8. (canceled)

9. The tiled display device of claim 1, wherein the individual displaying status representing the displays are not tiled.

10. The tiled display device of claim 1, wherein when the displaying status is a tiled displaying status, the compensating controlling signal is transmitted from the processor to the driving circuit of each of the displays.

11. A driving method of a tiled display device, comprising:
driving a signal source to output a display signal to a processor;
driving a detecting element of the processor to detect a displaying status of a plurality of displays of the tiled display device to generate a detecting signal;
driving the processor to determine whether to output a compensating controlling signal according to the detecting signal;
driving a plurality of driving circuits of the displays to adjust a brightness of a plurality of boundary pixel units, which are located at a boundary region of each of the displays, according to the compensating controlling signal; and
driving the boundary pixel units of the displays and a plurality of pixel units, which are located at a display region of each of the displays, to display a screen;
wherein when the displaying status is an individual displaying status, the boundary region of each of the displays is not compensated.

12. The driving method of the tiled display device of claim 11, wherein the boundary pixel units are divided into a plurality of areas, each of the areas comprises a portion of the boundary pixel units, each of the areas comprises B boundary pixel units, and is satisfied by the following condition:
$$B = C \times D ; and$$
$$C \geq 2 , and D \geq 1 ;$$
wherein C and D represent a number of a plurality of rows and a number of a plurality of columns of each of the areas, respectively, and the driving circuits adjust the brightness of one of B boundary pixel units of each of the areas according to the compensating controlling signal.

13. The driving method of the tiled display device of claim 12, wherein a distance of adjacent two of the displays is the same as a width of another portion of the boundary pixel units, a number of the another portion of the boundary pixel units is 2 A, the brightness of the one of B boundary pixel units of each of the areas is C×(D+A) times of a brightness of the pixel units, and a brightness of the other of the boundary pixel units in each of the areas is zero.

14. The driving method of the tiled display device of claim 11, wherein the boundary pixel units comprises a first column pixel unit and a second column pixel unit, the first column pixel unit has a first brightness, the second column pixel unit has a second brightness, the pixel units have a third brightness, and both of the first brightness and the second brightness are greater than the third brightness.

15. The driving method of the tiled display device of claim 14, wherein two first column pixel units and two second column pixel units of the adjacent two of the displays are disposed symmetrically.

16. The driving method of the tiled display device of claim 11, wherein the processor is one of a Central Processing Unit, a Graphics Processing Unit or an Image Signal Processor.

17. The driving method of the tiled display device of claim 11, wherein a number of the displays is at least two.

18. (canceled)

19. The driving method of the tiled display device of claim 11, wherein the individual displaying status representing the displays are not tiled.

20. The driving method of the tiled display device of claim 11, wherein when the displaying status is a tiled displaying status, the compensating controlling signal is transmitted from the processor to the driving circuit of each of the displays.
